(19) United States
(12) Patent Application Publication
(10) Pub. No.: US 2012/0114537 A1
(43) Pub. Date: May 10, 2012

(54) Reformer

(76) Inventor: In-Hyuk Son, Yongin-si (KR)

(21) Appl. No.: 13/137,012

(22) Filed: Jul. 15, 2011

(30) Foreign Application Priority Data
Nov. 4, 2010 (KR) 10-2010-0109173

(51) Int. Cl. B01J 8/00

(52) U.S. Cl. 422/626; 422/625; 422/629

(57) ABSTRACT

A reformer includes a heating unit and a reforming unit. The heating unit receives oxidation fuel and generates heat using an oxidation reaction. The reforming unit includes a first reaction part formed around the heating units and performing a reforming reaction; a second reaction part formed around the first reaction part and reducing carbon monoxide; and a mixing-reaction part connecting the outlet end of the first reaction part with an inlet of the second reaction part such that fluid can flow therebetween, and performing simultaneously a reforming reaction and a reduction reaction of carbon monoxide. The mixing-reaction part includes a mixed catalyst layer that can simultaneously perform reforming and reducing carbon monoxide, such that it is possible to increase the generation amount of hydrogen and reduce the generation amount of carbon monoxide.

### BACKGROUND

1. Field

The present embodiment relates to a reformer, in detail, a reformer that can stably process CO.

2. Description of the Related Art

A reforming reaction in fuel cells is a reaction that produces hydrogen, which is fuel used for the fuel cells, from hydrocarbon-based fossil fuel. A device that performs the reforming reaction is called a fuel processor. The fuel processor may further include a reactor for reducing concentration of carbon monoxide and a desulfurizer for removing sulfur from the fuel, if needed, in addition to a reformer providing a reforming reaction.

### SUMMARY

According to an embodiment, there is provided a reformer including a heating unit that receives oxidation fuel and generates heat by using an oxidation reaction, and a reforming unit that includes a first reaction part disposed around the heating unit and performing a reforming reaction, a second reaction part disposed around the first reaction part and reducing carbon monoxide, and a mixing-reaction part connecting an outlet end of the first reaction part with an inlet of the second reaction part such that fluid can flow therebetween, the mixing-reaction part simultaneously performing a reforming reaction and a reduction reaction of carbon monoxide.

The mixing-reaction part may include a mixed catalyst that catalyzes a steam reforming reaction and a high-temperature water gas shift reaction.

The mixed catalyst may be a plurality of metal particles.

The metal particles may have diameters within a range of 1 mm to 3 mm.

The mixed catalyst may include white gold and Pt—Rh.

The mixed catalyst may include an Ru/alumina catalyst.

The first reaction part may perform reforming in a steam reforming reaction.

The second reaction part may reduce carbon monoxide in a water gas shift reaction.

The heating unit may include a first oxidation part that is in a shape of a cylinder or a polygonal cylinder, wherein the first oxidation part has an oxidation fuel inlet at one end through which oxidation fuel flows into the first oxidation part, has an AOG inlet at another end through which an anode off gas flows into the reformer, and has a first oxidation catalyst layer disposed therein; and a second oxidation part that is disposed around the first oxidation part, wherein the second oxidation part is connected with an outlet end of the first oxidation part such that fluid can flow therebetween, has a second oxidation catalyst layer therein, and has a flue gas outlet through which a flue gas is discharged after oxidation.

A fuel distributor that uniformly distributes fuel may be disposed between the oxidation fuel inlet and the first oxidation catalyst layer.

An anti-backfire part may be disposed between the fuel distributor and the first oxidation catalyst layer.

According to an embodiment, there is provided a reformer including a reforming unit that includes a first reaction part disposed around a heating unit, the first reaction part including a catalyst that catalyzes a reforming reaction in a fluid that passes through the first reaction part, a second reaction part disposed around the first reaction part, the second reaction part including a catalyst that reduces a concentration of carbon monoxide in a fluid that passes through the second reaction part, and a mixing-reaction part connecting an outlet end of the first reaction part with an inlet of the second reaction part such that a fluid can flow therebetween, the mixing-reaction part includes a mixed catalyst that catalyzes a reforming reaction and reduces a concentration of carbon monoxide in a fluid that passes through the mixing-reaction part.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram schematically showing a fuel cell system including a reformer.

FIG. 2 illustrates a schematic longitudinal cross-sectional view showing a reformer.

FIG. 3 illustrates a longitudinal cross-sectional view schematically showing a reformer according to an embodiment of the present invention.

FIG. 4 illustrates a transverse cross-sectional view of the reformer shown in FIG. 3, taken along the line IV-IV.

FIG. 5 illustrates a longitudinal cross-sectional view schematically showing a reformer according to another embodiment.

### DETAILED DESCRIPTION

Korean Patent Application No. 10-2010-0109173, filed on Nov. 4, 2010, in the Korean Intellectual Property Office, and entitled: “Reformer” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete and will fully convey the scope of the invention to those skilled in the art.

In the drawing figures, the dimensions of layers and regions may be exaggerated for clarity of illustration. It will also be understood that when an object is referred to as being “between” two other objects, it can be the only object between the two other objects, or one or more intervening objects may also be present. Like reference numerals refer to like elements throughout.

An external reforming type reformer is composed of a heating unit and a reforming reaction unit. The heating unit supplies heat for a reforming reaction in the reforming reaction unit and the reforming reaction unit produces a hydrogen-rich gas by reformation fuel. The reforming reaction unit reforms the supplied fuel, using steam reforming (SR, STR), partial oxidation (PDX), or autothermal reforming (ATR), which is the combination of the steam reforming and the partial oxidation. The steam reforming (SR) reaction, which is a method of acquiring hydrogen from a reaction of hydrocarbon fuel with steam, has the advantage of increasing output of a fuel cell because it can provide high-concentration hydrogen. However, heat should be supplied from the outside, since the steam reforming reaction is an endothermic reaction.

In general, a reactor for reducing CO may be provided, if desired, after the reforming reaction. Typical reactions in the reactor for reducing CO are a water gas shift reaction and a CO preferential oxidation reaction. The reactor may be disposed right behind a water gas shift reactor and may reduce the concentration of carbon monoxide to about 0.1˜0.5% from about 10%. A reactor for reducing CO may also be called a CO shift converter. The water gas shift reaction may be classified into a high-temperature water shift reaction (HTS: at 400° C. to 500° C.) and a low-temperature water gas shift reaction (LTS: at 200° C. to 300° C.), in accordance with the reaction temperature. The CO preferential oxidation (PROX) reaction selectively oxidizes carbon monoxide by supplying air into the reactor, reduces the concentration of the carbon monoxide to a level of several ppm, and supplies a reformed gas to a fuel cell stack.

Reformate gas that remains unreacted after passing through the stack is referred to as AOG (Anode off gas). In the related art, the AOG has been burned by a specific catalytic burner or mixed with the atmosphere and then discharged, with the concentration of CO exhaust gas in the AOG reduced. However, the environmental standards have become stricter over the world and it is required to more productively manage the AOG to manufacture a fuel cell that is available in the interior. Accordingly, it is desirable to improve efficiency of a reformer, by considering and more positively using hydrogen (H₂) that is the main component of the AOG gas is, in addition to satisfying the environmental standards for air pollution by refraining from burning the AOG gas.

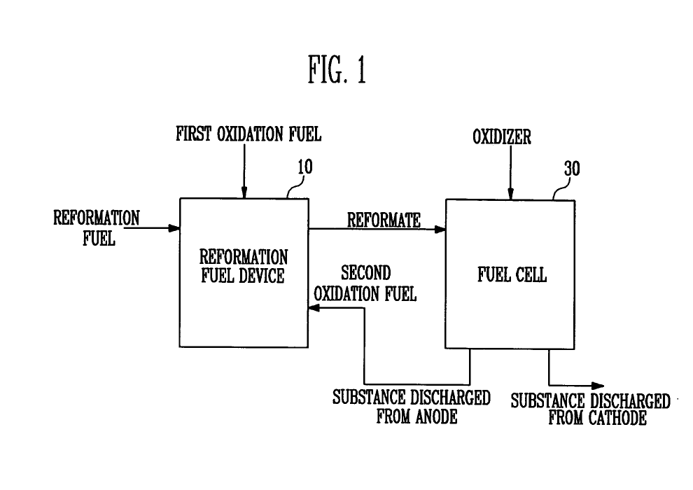

According to an embodiment shown in FIG. 1, a reformer 10 receives reformation fuel and converts the reformation fuel into reformate that is used for electric generation by a fuel cell 30. Since a heating unit may be required when the reformer 10 converts the reformation fuel into reformate by using a steam reforming (SR) reaction, a first oxidation fuel is supplied to generate heat. An AOG exhaust gas that is non-reacted fuel from a fuel electrode (anode) of the fuel cell may be supplied as second oxidation fuel into the reformer, in order to improve efficiency of the entire system. The reformer 10 may include a reactor that reduces carbon monoxide, using a water gas shift reaction (WGS) and a preferential oxidation (PROX) reaction. Herein, terms such as “reducing carbon monoxide” or “reduction of carbon monoxide” refer to reducing an amount or concentration of the carbon monoxide, and such terms are not limiting with respect to any particular reaction mechanism.

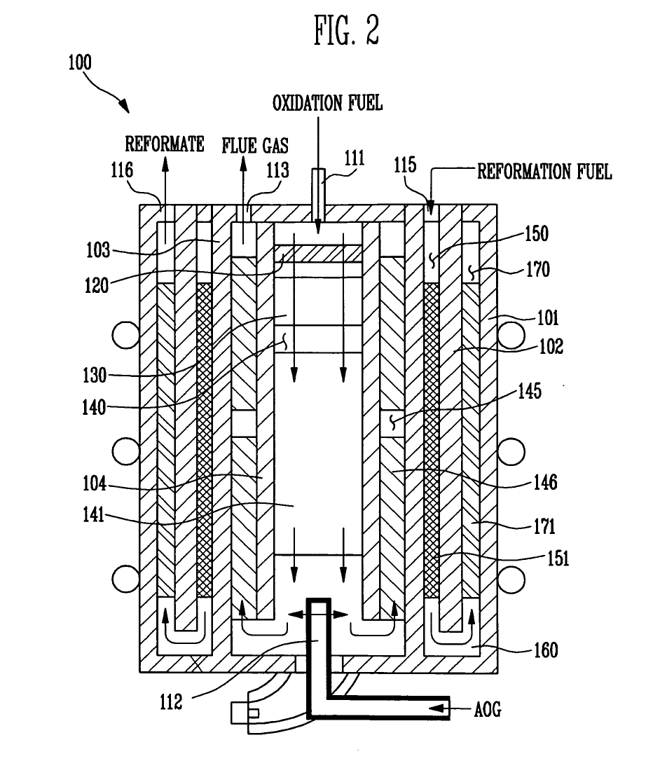

As shown in FIG. 2, a reformer 100 may include heating units 140, 145 at the center portion of the reformer with respect to the longitudinal center axis. The heating units 140, 145 may be hollow cylinders or hollow polygonal cylinders. A first reaction part 150 may be disposed around the heating units 140, 145, and a second reaction part 170 may be disposed around the first reaction part 150. The first reaction part 150 and the second reaction part 170 may be connected at the lower portions such that fluid can flow between the first reaction part 150 and the second reaction part 170. A thermal structure in which the center portion near the reformer center axis has the highest temperature and the temperature gradually decreases to the outside is formed by the above structure, such that a uniform oxidation temperature can be maintained. A reforming reaction is performed in the first reaction part 150 by the heat maintained as described above, and carbon monoxide is reduced in the second reaction part 170.

In order to perform reforming such that more hydrogen is produced in the reformer having the structure described above, it is possible to increase the size of the reformer itself and the amount of reforming catalyst. However, such an approach may not be economically feasible. On the other hand, when the amount of reforming catalyst itself is increased in a limited space, a process load of the carbon monoxide that is processed by the second reaction part 170 increases, such that a specific device for reducing the carbon monoxide is required. The present embodiment has been made to reduce the generation amount of carbon monoxide, in addition to increasing the generation amount of hydrogen, in a limited space.

A reformer 100a according to the embodiment described herein may be divided into a heating unit, which includes a first oxidation part 140 and a second oxidation part 145, and a reforming unit, which includes a first reaction part 150, a second reaction part 160, and a third reaction part 170, in accordance with the types and flow of fluid that flows therein.

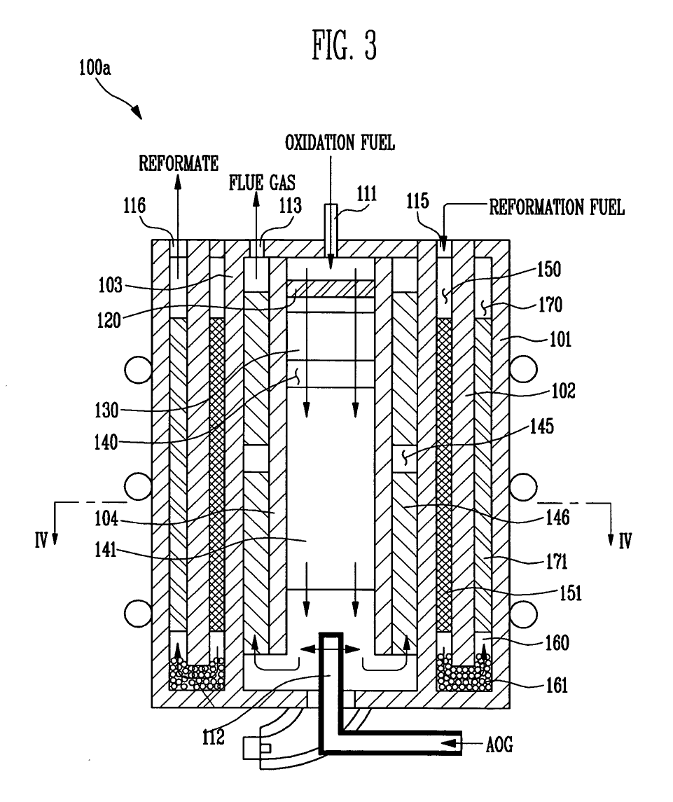

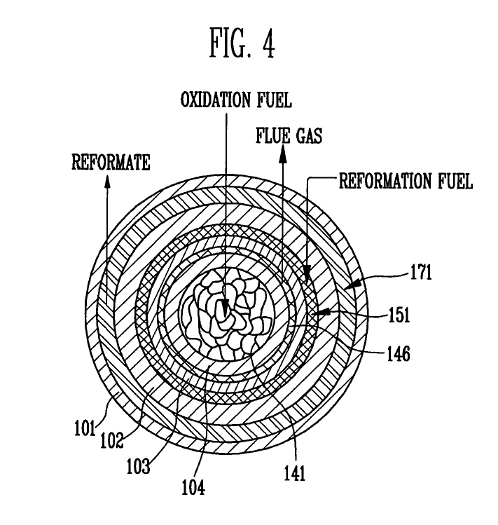

The reforming unit is described with reference to FIGS. 3 and 4. The reformer according to this embodiment may be equipped with an integrated reactor for carrying out a reforming reaction and reducing carbon monoxide. In particular, steam reforming may be selected as a reforming method to maintain durability of the reformer 100a for a long period of time, and a water gas shift reaction may be used to reduce carbon monoxide, but the present invention is not limited to those methods.

The first reaction part 150 may occupy a predetermined space surrounding the heating unit. The inner wall 102 of the reforming unit may be formed as a hollow cylinder or a hollow polygonal cylinder and may surround the outer wall 103 of the second oxidation part 145 of the heating unit. The first reaction part 150, which occupies a predetermined space, may be formed between the inner wall 102 of the reforming unit and the outer wall 103 of the heating unit. As described above, a reforming catalyst layer 151 for catalyzing a steam reforming reaction may be disposed in the first reaction part 150. The amount of reforming catalyst may be selected in accordance with a generation amount of reformation fuel and the amount of carbon monoxide that should be processed. For example, in an embodiment used to accurately measure and compare an effect due to a presence or absence of a mixing-reaction part 160 described below, the reforming catalyst layer 151 was a 600 cpsi (cells per square inch) metal monolith that was coated with Ni or a precious metal catalyst in an amount of 80 cc, such an amount being suitable for the generation of hydrogen in an amount of 5 SLPM (standard liters per minute). More catalyst may be provided when an amount of hydrogen generation greater than 5 SLPM is desired. However, as described above, when only the amount of catalyst is increased, the generation amount of carbon monoxide after reformation and the process load of carbon monoxide in the second reaction part 170 are increased.

The second reaction part 170 may occupy a predetermined space surrounding the inner wall 102 of the reforming unit. The outer wall 101 of the reforming unit may be formed in a hollow cylinder or a hollow polygonal cylinder and surrounds the inner wall 102 of the reforming unit. The second reaction part 170, which occupies a predetermined space, may be formed between the inner wall 102 of the reforming unit and the outer wall 101 of the reforming unit. A water gas shift catalyst layer 171 for reducing carbon monoxide may be disposed in the second reaction part 170. The water gas shift catalyst layer 171, through a water gas shift reaction, reduces the content of carbon monoxide in a reformate flowing into the second reaction part 170 from the lower end or inlet of the second reaction part 170. The reformate having the carbon monoxide reduced through the water gas shift catalyst layer 171 is discharged to the outside through a reformate outlet 116. The catalyst for the water gas shift may be made of a carrier, or a support and an activated substance immersed in the carrier or the support. A Cu—Zn catalyst may be used as the shift catalyst. If desired, the water gas shift catalyst layer 171 may be provided as a high-temperature water gas shift (HTS) catalyst layer having an operational temperature range of about 300˜500° C. and/or a low-temperature water gas shift (LTS) catalyst layer having an operational temperature range of about 150˜250° C.

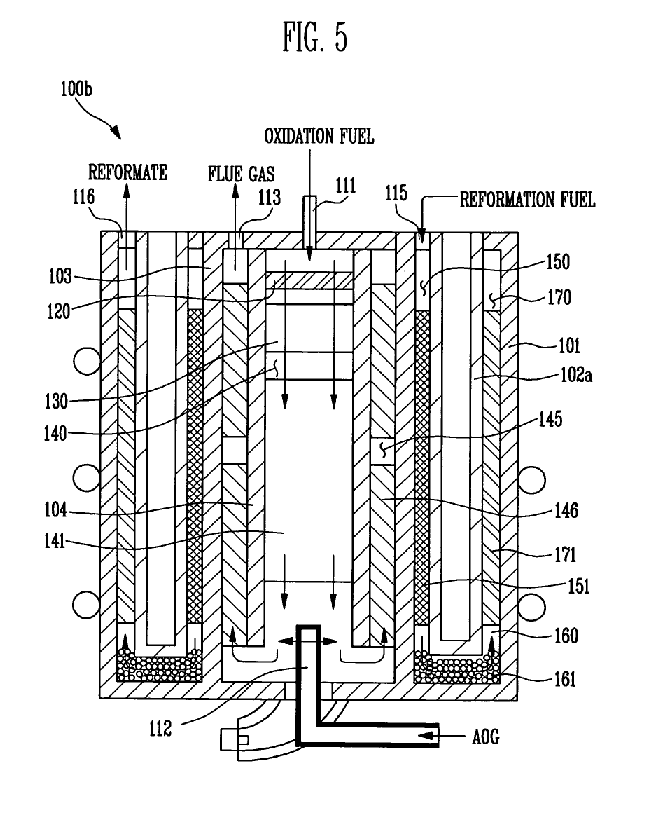

The inner wall of the reforming unit may be adjusted in thickness or may be adjusted in thermal conductivity in order to maintain the temperature outside the inner wall 102 of the reforming unit at a predetermined level. The thickness of the wall may be increased in order to relatively reduce the temperature outside the inner wall 102 of the reforming unit. Further, the inner wall 102 of the reforming unit may be a double wall, as shown in FIG. 5. It is possible to adjust thermal conductivity by forming an air layer or by filling a foreign substance inside the double wall, when the inner wall 102 of the reforming unit is a double wall.

The mixing-reaction part 160 may be a donut-shaped space and connects the lower ends of the first reaction part 150 and the second reaction part 170. The lower end of the first reaction part 150 may be an outlet of the first reaction part 150 and the lower end of the second reaction part 170 may be an inlet of the second reaction part, such that the outlet of the first reaction part 150 is connected through the mixing-reaction part 160 with the inlet of the second reaction part 170 such that fluid can flow therebetween. The reformate reformed through the first reaction part 150 may be transmitted to the second reaction part 170 through the mixing-reaction part 160. The mixing-reaction part 160 may further include a mixing catalyst layer 161 that simultaneously performs a reforming reaction and a reduction reaction of carbon monoxide. The mixing catalyst layer 161 may include catalysts that are in the form of a plurality of metal particles for the steam reforming reaction and the high-temperature gas shift (HTS) reaction. The reformate transmitted from the first reaction part 150 described above undergoes the steam reforming reaction and the high-temperature water gas shift reaction while moving through holes or pores of the mixing catalyst layer 161 having metal particles. The reformate that has passed through the mixing catalyst layer 161 flows into the lower end of the second reaction part 170 and undergoes an additional reduction reaction of carbon monoxide.

The mixing catalyst layer 161 may be formed of metal particles having diameters of 1 mm to 3 mm. When the diameters of the metal particles of the mixing catalyst layer 161 are above 3 mm, the total sum of surface areas of the metal particles decreases, such that the performance of the catalyst may be reduced, thereby reducing efficiency of reforming and reduction carbon monoxide. On the other hand, when the diameters of the metal particles of the mixing catalyst layer 161 are below 1 mm, the holes or pores between particles are narrow and pressure of the mixing catalyst layer 161 increases, such that a specific pressure control device may be required. The mixing catalyst may include white gold and Pt—Rh or Ru/alumina.

The heating unit is described with reference to FIGS. 3 and 4. The heating unit is roughly divided into a first oxidation part 140 and a second oxidation part 145.

The first oxidation part 140 may be formed inside the inner wall 104 of the heating unit. is the first oxidation part 140 may be formed as a hollow cylinder or a hollow polygonal cylinder. An oxidation fuel inlet 111 through which oxidation fuel flows into the first oxidation part 140 may be formed at one end of the first oxidation part 140. If desired, an AOG inlet 112 through which the anode off gas flows into the first oxidation part 140 may be formed at an opposite end to the oxidation fuel inlet 111.

The second oxidation part 145 may occupy a predetermined space surrounding the inner wall 104 of the heating unit. That is, the outer wall 103 of the heating unit may be formed in a hollow cylinder or a hollow polygonal cylinder and surrounds the inner wall 104 of the heating unit. The second oxidation part 145, which occupies a predetermined space, may be formed between the inner wall 104 of the heating unit and the outer wall 103 of the heating unit. The second oxidation part 145 may be connected to the lower end of the first oxidation part 140 such that fluid can flow therebetween. Further, an exhaust gas outlet 113 through which an exhaust gas is discharged after oxidation may be formed at the upper end of the second oxidation part 145.

The oxidation fuel may include a main fuel, such as LPG, that generates heat using an oxidation reaction. The oxidation fuel may include a alcohol, such as methanol, a hydrocarbon, such as methane and butane, a fossil fuel, such as LNG, a biomass gas, a landfill gas, or composites of these fuels. The anode off gas includes a non-reacted gas containing hydrogen, as the main component, which is discharged from the fuel electrode after electricity is generated in the fuel cell stack (not shown).

A first oxidation catalyst layer 141 is formed in the first oxidation part 140. The first oxidation catalyst layer 141 may be in the form of a mesh or monolith type of support having a space allowing fluid to flow and an activated substance may be coated on the surface of the support. The first oxidation catalyst layer 141 may improve the burning rate of the oxidation fuel or the AOG by inducing stable combustion without flashback, and may adjust the positions where hot spots are formed. The activated substance may be Pd, Pt, Co₃O₄, PdO, Cr₂O₃, Mn₂O₃, CuO, Fe₂O₃, V₂O₃, NiO, MoO₃, TiO₂, or composites thereof. The supports of the first oxidation catalyst layer 141 may have a cell concentration of about 400 to 600 CPSI (cell per square inch), in order to maintain appropriate fluid pressure and make oxidation reaction of the fuel efficient.

A second oxidation catalyst layer 146 may be formed in the second oxidation part 145. The second oxidation catalyst layer 146 may be in the form of a mesh or monolith type of support having a cell concentration of about 100 to 200 CPSI. An oxidation catalyst may be coated to the surfaces of the support. The support may be made of metal, alloys, or composite materials, which have high melting point, such as chrome-based stainless steel (Fe—Cr) to achieve high appropriate durability against high-temperature heat. The oxidation catalyst may be Pd, Pt, Co₃O₄, PdO, Cr₂O₃, Mn₂O₃, CuO, Fe₂O₃, V₂O₃, NiO, MoO₃, TiO₂, or composites thereof, similar to the first oxidation catalyst layer 141. The first oxidation catalyst layer 141 may be disposed in the first oxidation part 145 at a predetermined distance from the second oxidation catalyst layer 146 in the second oxidation part 146. The second oxidation catalyst layer 146 may be disposed in two portions spaced at a predetermined distance in the second oxidation part 145.

A fuel distributor 120 may be disposed between the oxidation fuel inlet 111 and the first oxidation catalyst layer 141. The fuel distributor 120 may have a plurality of holes formed through the edge of a body having a disk shape, in the thickness direction. The fuel distributor 120 may uniformly distribute the oxidation fuel into the first oxidation part 140. The fuel distributor 120 may uniformly distribute heat by inducing combustion of the oxidation fuel around or outside the center axis where the reaction temperature is relatively lower than the portion around the center axis. The material of the fuel distributor 120 may be a metal, alloy, or composite material, which have durability within the operational temperature range of the first oxidation part 140. The operational temperature of the first oxidation part 140 may depend on the kind of oxidation fuel that is used.

Further, an anti-backfire part 130 may be disposed between the fuel distributor 120 and the first oxidation catalyst layer 141. The anti-backfire part 130 may prevent hot heat points from being formed at the upper end of the first oxidation catalyst layer 141, where the oxidation reaction is the most active, and may prevent combustion from flowing back to the fuel distributor 120. The anti-backfire part 130 may be a cylindrical porous member or a metal monolith. The anti-backfire part 130 may be a metal monolith having about 400 to 600 CPSI to have the same cell concentration as the support of the first oxidation catalyst layer 141.

The reformer may include other parts, such as an igniter or a pre-heater, are not described herein.

The operation of this embodiment and a comparative experiment example are described hereafter with reference to FIG. 5.

The oxidation fuel flows into the first oxidation part 140 through the oxidation fuel inlet 111 and is ignited by a specific device, such as an igniter. Most of the oxidation fuel is oxidized in the first oxidation catalyst layer 141 while generating heat. The oxidized exhaust gas and some of the first oxidation fuel that is not oxidized, flow to the second oxidation part 145.

The AOG may flow into the lower end of the first oxidation part 140 through the AOG inlet 112. The AOG flowing into the first oxidation part 140 is mixed with the oxidation fuel and moves to the second oxidation part 145. The flue gas, non-reacted oxidation fuel, and AOG may be oxidized through the second oxidation catalyst layer 146 in the second oxidation part 145. In this process, since the second oxidation catalyst layer 146 may have cell concentration lower than the first oxidation catalyst layer 141, backpressure in the first oxidation part 140 may be maintained substantially at a predetermined level. The flue gas generated after being oxidized in the second oxidation part 145 may be discharged outside through a flue gas outlet 113. The oxidation fuel and the AOG may generate heat while being oxidized through in a path through the first oxidation part 140 and the second oxidation part 145.

The reformation fuel may flow into the first reaction part 150 through the reformation fuel inlet 115. The reformation fuel flowing into the first reaction part 150 may be reformed in a reformation catalyst layer 151 with the help of heat generated from the heating units 140, 145. The reformed reformate may flow into the mixing-reaction part 160, where any remaining reformation fuel may be reformed by the mixing catalyst layer 161 in the mixing-reaction part 160. Also in the mixing-reaction part, carbon monoxide generated in the first oxidation part 150 may be reduced. The gas that has passed through the mixing reaction part 160 may move to the second reaction part 170. Carbon monoxide that is present in the gas that passes from the mixing reaction part 160 to the second reaction part 170 is reduced by the water gas shift catalyst layer 171. Finally, the reformed reformate is discharged through the reformate outlet 116.

A comparative experiment example for when the mixing catalyst layer 161 according to this embodiment is not provided is described hereafter. As described above, the reforming catalyst layer 150 has metal monolith support having a cell concentration of 600 cpsi. The surfaces of the supports were coated with Ni or a precious metal catalyst in an amount of 80 cc, which is the catalyst amount appropriate to a flow of 5 LPM, with respect to hydrogen generation. The catalyst of the water gas shift catalyst layer 171 was a Cu—Zn catalyst.

In this environment, reforming performance of about 4.3 SLPM was shown in the first reaction part 150 and carbon monoxide having a content ratio of about 10% to 12% was produced after steam reforming reaction.

The mixing catalyst layer 161 composed of metal particle catalysts having a diameter of about 1.5 mm, made of white gold and Pt—Rh of this embodiment was provided under different conditions, and experiments were repeated under the external environment. As a result, the reforming performance was improved to about 9 SLPM, and the amount of carbon monoxide generated after the steam reforming reaction could be reduced up to about 5% to 8% in the content ratio. Meanwhile, the content ratio of the carbon monoxide was reduced up to 4% to 7%, in an experiment replacing the catalyst with a catalyst of Ru/alumina. It can be considered as the result that the function of the high-temperature water gas shift (HTS) was strengthened.

The present embodiments provide a reduced process load of a carbon monoxide reducer by increasing the amount of hydrogen produced in a limited space of a reformer and simultaneously reducing the amount of carbon monoxide.

By way of summary and review, a reformer may include a mixing catalyst layer that can simultaneously perform reforming and reduce an amount of carbon monoxide, such that it is possible to increase the generation amount of hydrogen and reduce the generation amount of carbon monoxide.

In particular, if the reformer includes a catalyst that can accelerates a high-temperature water gas shift (HTS) reaction in the mixed catalyst layer, it is possible to increase the generation amount of hydrogen to 1805 and reduce the generation amount of carbon monoxide to about 50%, as compared with when the mixing catalyst layer is not provided.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope as set forth in the following claims.

What is claimed is:

1. A reformer comprising:
a heating unit that receives oxidation fuel and generates heat by using an oxidation reaction; and
a reforming unit that includes:
a first reaction part disposed around the heating unit and performing a reforming reaction,
a second reaction part disposed around the first reaction part and reducing carbon monoxide, and
a mixing-reaction part connecting an outlet end of the first reaction part with an inlet of the second reaction part such that fluid can flow therebetween, the mixing-reaction part simultaneously performing a reforming reaction and a reduction reaction of carbon monoxide.

2. The reformer as claimed in claim 1, wherein the mixing-reaction part includes a mixed catalyst that catalyzes a steam reforming reaction and a high-temperature water gas shift reaction.

3. The reformer as claimed in claim 2, wherein the mixed catalyst is a plurality of metal particles.

4. The reformer as claimed in claim 3, wherein the metal particles have diameters within a range of 1 mm to 3 mm.

5. The reformer as claimed in claim 2, wherein the mixed catalyst includes white gold and Pt—Rh.

6. The reformer as claimed in claim 2, wherein the mixed catalyst includes a Ru/alumina catalyst.

7. The reformer as claimed in claim 1, wherein the first reaction part performs reforming in a steam reforming reaction.

8. The reformer as claimed in claim 1, wherein the second reaction part reduces carbon monoxide in a water gas shift reaction.

9. The reformer as claimed in claim 1, wherein the heating unit includes:
a first oxidation part that is in a shape of a cylinder or a polygonal cylinder, wherein the first oxidation part has an oxidation fuel inlet at one end through which oxidation fuel flows into the first oxidation part, an AOG inlet at another end through which an anode off gas flows into the reformer, and a first oxidation catalyst layer disposed therein; and
a second oxidation part disposed around the first oxidation part, the second oxidation part being connected with an outlet end of the first oxidation part such that fluid can flow therebetween, having a second oxidation catalyst layer therein and having a flue gas outlet through which a flue gas is discharged after oxidation.

10. The reformer as claimed in claim 9, wherein a fuel distributor that uniformly distributes fuel is disposed between the oxidation fuel inlet and the first oxidation catalyst layer.

11. The reformer as claimed in claim 10, wherein an anti-backfire part is disposed between the fuel distributor and the first oxidation catalyst layer.

12. A reformer comprising:
a reforming unit that includes:
a first reaction part disposed around a heating unit, the first reaction part including a catalyst that catalyzes a reforming reaction in a fluid that passes through the first reaction part,
a second reaction part disposed around the first reaction part, the second reaction part including a catalyst that reduces a concentration of carbon monoxide in a fluid that passes through the second reaction part, and
a mixing-reaction part connecting an outlet end of the first reaction part with an inlet of the second reaction part such that a fluid can flow therebetween, the mixing-reaction part including a mixed catalyst that catalyzes a reforming reaction and reduces a concentration of carbon monoxide in a fluid that passes through the mixing-reaction part.
